(19) United States
(12) Patent Application Publication
(10) Pub. No.: US 2010/0018129 A1
(43) Pub. Date: Jan. 28, 2010

(54) Sill Flashing

(76) Inventors: Stephen John Hotton, Kaiapoi (NZ); Michael Anticich, Kaiapoi (NZ)

Correspondence Address: JOHN ALEXANDER GALBREATH, 2516 CHESTNUT WOODS CT, REISTERSTOWN, MD, 21136, US

(21) Appl. No.: 12/442,115

(22) PCT Filed: Sep. 4, 2007
(86) PCT No.: PCT/NZ2007/000247

§ 371 Date: Mar. 20, 2009

(30) Foreign Application Priority Data
Oct. 5, 2006 (NZ) 550346

(51) Int. Cl. E06B 7/26

(52) U.S. Cl. 52/58

(57) ABSTRACT

A sill flashing adapted to be mounted below and parallel to the lower edge of a window frame, said sill flashing including: -a first portion adapted to lie behind the lower edge of a window frame; a second portion adapted to lie between the cladding and the framing beneath the lower edge of the window frame; a third portion designed to provide an outwardly inclined cover for the top edge of the cladding below the lower edge of the window frame; a fourth portion adapted to brace the lower edge of said third portion; wherein said first, second, third and fourth portions are formed integrally with each other.

### TECHNICAL FIELD

The present invention relates to an improved sill flashing for use in combination with window frames, door frames, French window frames or sliding door frames. The flashing of the present invention has been developed specifically for use in combination with aluminium window frames, and therefore will be described with particular reference to this application. However, it should be appreciated that the flashing of the present invention is not restricted to this application, and in the specification the term “windows” includes doors, French windows, sliding doors and all similar components, and the frames may be made of any material, e.g. aluminium, plastics, wood.

### BACKGROUND ART

A common method of building construction is to erect a building frame (typically of wood), cover the frame with a layer of building paper on the exterior of the building, and then apply cladding over the building paper. The cladding may be any of a wide variety of materials, e.g. plaster based preparations, sheets of simulated or synthetic stone, weatherboard, fibre cement or polystyrene.

The frames for windows are set into the framing, and the cladding butts up against the edges of each window frame. The join between the cladding and each vertical side edge of the window frame usually is sealed with a known sealant compound. The join along the top of the window frame usually is protected with the use of a known type of window head flashing. The join between the cladding and the bottom of the window frame is particularly prone to leaking, since rain tends to drive up under the window frame and into the wall cavity. Ideally, water is prevented from getting into the wall cavity at all, but since this is not always possible, it is important to provide a drainage path so that any water which does get into the wall cavity can drain out easily without damaging the cladding or the framing.

### DISCLOSURE OF INVENTION

The sill flashing disclosed in New Zealand Patent No. 532728 disclosed a sill flashing which provided a reliable seal between the cladding and the bottom of the window frame, and also provided easy drainage for any water which penetrated past the flashing.

However, the flashing disclosed in New Zealand Patent No. 532728 was made in two pieces, which had to be fitted together to make the complete flashing. This increased both the production and the fitting cost, and also increased the risk of the fitting being incorrectly installed.

It is therefore an object of the invention to provide a sill flashing which, while retaining all of the advantages of the flashing of New Zealand Patent No. 532728, is formed as a single piece and thus is cheaper to make and install, and less liable to installation errors.

The present invention provides a sill flashing adapted to be mounted below and parallel to the lower edge of a window frame, said sill flashing including: a first portion adapted to lie behind the lower edge of a window frame; a second portion adapted to lie between the cladding and the framing beneath the lower edge of the window frame; a third portion designed to provide an outwardly inclined cover for the top edge of the cladding below the lower edge of the window frame; and a fourth portion adapted to brace the lower edge of said third portion; said first, second, third and fourth portions being formed integrally with each other.

Preferably the fourth portion is located so that the fourth portion in combination with the adjacent parts of the third and second portions form a channel for receiving the upper edge-of building cladding material, in use.

Preferably, the flashing further comprises an end cap adapted to be a tight push-fit or a driven fit over each end of the flashing and dimensioned to close off substantially the whole of the end of the flashing.

### BRIEF DESCRIPTION OF DRAWINGS

By way of example only, a preferred embodiment of the present invention is described in detail with reference to the accompanying drawings, in which:

FIG. 1 shows a longitudinal section through part of a building wall and the lower part of a window frame fitted with the sill flashing of the present invention;

FIG. 2 shows a side view of an end cap used in combination with the flashing of FIG. 1; and

FIG. 3 shows a side view of the flashing of FIG. 1 with the end cap in place.

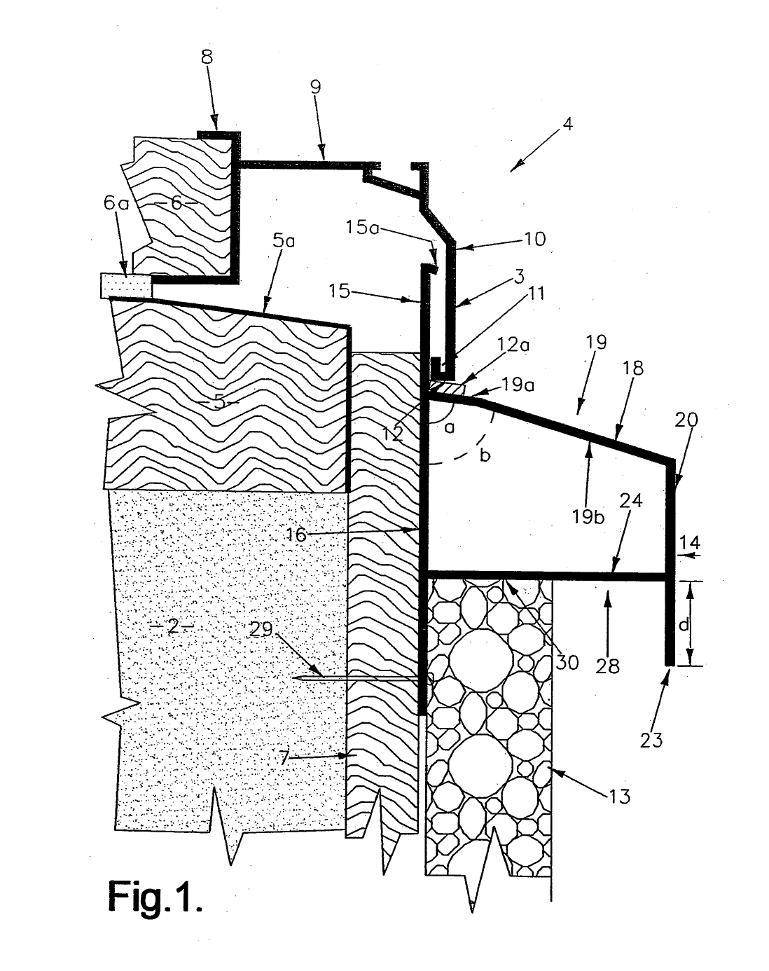

### BEST MODE FOR CARRYING OUT THE INVENTION

Referring to the drawings, the wall of a building adjacent the lower edge 3 of a window frame 4 consists of framing 2 supporting a horizontal sill trimmer 5, which supports an inner window reveal 6 and a series of spaced cavity battens 7. A packing strip 6a is located between the sill trimmer 5 and the reveal 6. The upper surface of the sill trimmer 5 is protected by a flexible waterproof wrap 5a of known type.

The window frame 4 is a known type and includes a channel portion 8 which fits over the inner window reveal, a portion 9 which provides seating for the glazing (not shown), and an outer portion 10 which forms the outer surface of the window frame. The lower edge of the portion 10 is in-turned to form a channel 11 with a substantially horizontal lower surface 12.

The cavity battens 7 are vertical strips of timber spaced apart in a horizontal plane and secured to the sill trimmer 5 and/or the framing 2. The purpose of the cavity battens is to provide a series of air gaps between the framing 2 and the cladding, which is shown as a layer of polystyrene 13 covered by a cement based plaster 1 3a, but which may be of any suitable type (e.g. metal sheet cladding, weatherboard).

A sill flashing 14 in accordance with the present invention comprises a first portion 15 which is formed integrally with, and coplanar with, a second portion 16; the portions 15 and 16 together provide a substantially vertical flat plate which extends the full length of the window frame and slightly beyond each end of the frame. The first portion 15 is formed with a small projecting edge 15a along the upper edge of the portion 15.

The third portion 18 of the sill flashing 14 comprises an inclined portion 19 formed integrally with a substantially vertical portion 20. The third portion 18 is formed integrally with the second portion 16. The part 19a of the inclined portion 19 is inclined to the portion 15 at an angle ‘a’ of slightly greater than 90° (e.g. 93°); the part 19b is inclined to the portion 15 at an angle ‘b’of about 15°.

The lower edge 23 of the portion 20 is braced by a fourth portion 24 which is formed integrally with the rest of the flashing and which extends substantially horizontally between a position a short distance ‘d’ above the edge 23 to the second portion 16, The distance ‘d’ is sufficient to provide a channel 28 to receive the end of the cladding 13.

In use, the horizontal lower surface 12 of the channel 11 of the window frame rests on spaced blocks 12a supported upon and secured to the part 19a. Air can pass under the edge 12 from outside the window-frame, but water is prevented from driving up and under the frame by the inturned edge 15a.

The second portion 16 of the flashing is secured in position by a series of spaced screws 29 which extend through the portion 16 into the underlying cavity batten 7 and framing 2.

The top surface 30 of the cladding 13 is received in the channel 28, and the portion bracket 24 prevents water from being driven up under the third portion 18.

When the flashing is being installed, the portion 16 is secured to the battens 7 and framing 2 by the screws 29, then the cladding 13 is positioned with its top surface 30 under the portion 24 in the channel 28.

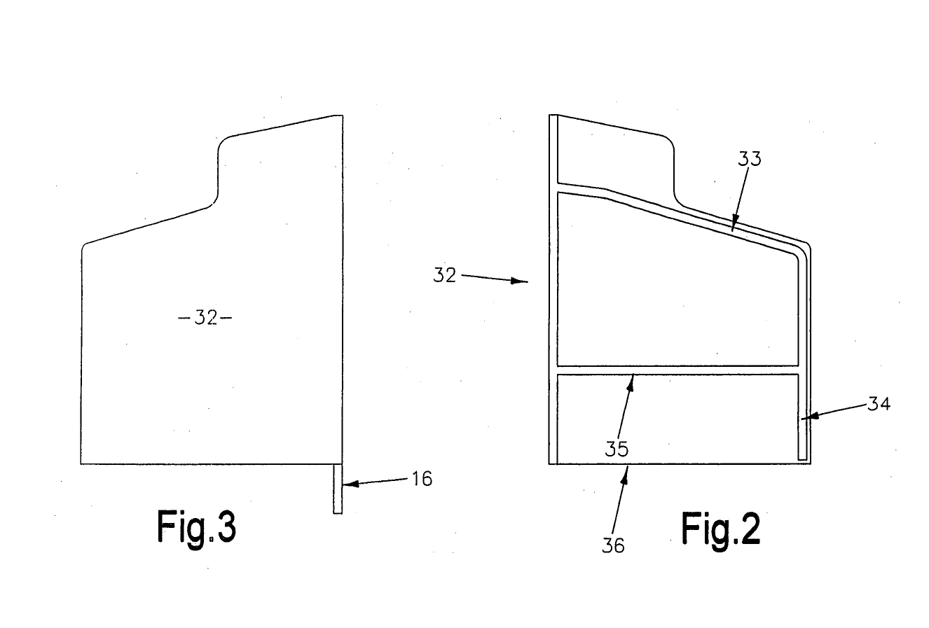

As shown in FIGS. 2 and 3, the exposed ends of the flashing are closed off by end caps 32. Each end cap closes off substantially the whole of the flashing end—only part of the lower end of portion 16 is left exposed.

Each end cap 32 is a single plate, planar on its outer (exposed) side (see FIG. 3) but grooved on its inner side: -as shown in FIG. 2, 3 continuous grooves 33, 34, 35 are formed to receive the ends of the third portion 18, (including the portion 20) and the fourth portion 24 respectively. The caps 32 are push-fitted to the ends of the flashing once the flashing has been secured in place.

The portion 36 of each end cap 32 below the groove 35 ends just below the edge 23 of the flashing, and thus provides an end for the channel 28.

The sill flashing may be made of any suitable material, e.g. an aluminium extrusion, with the first, second, third and fourth portions of the flashing formed integrally.

The above-described sill flashing may be used in combination with any of a wide variety of head- and jamb-(side) flashings.

1. A sill flashing adapted to be mounted below and parallel to the lower edge of a window frame, said sill flashing including:
a first portion adapted to lie behind the lower edge of a window frame;
a second portion adapted to lie between the cladding and the framing beneath the lower edge of the window frame;
a third portion designed to provide an outwardly inclined cover for the top edge of the cladding below the lower edge of the window frame;
a fourth portion adapted to brace the lower edge of said third portion;
wherein said first, second, third and fourth portions are formed integrally with each other.

2. The flashing as claimed in claim 1 wherein said the first and second portions are coplanar.

3. The flashing as claimed in claim 1 wherein the fourth portion extends from the third portion to the second portion.

4. The flashing as claimed in claim 3 wherein the fourth portion is located so that the fourth portion in combination with the adjacent parts of the third and second portions form a channel for receiving the upper edge of building cladding material, in use.

5. The flashing as claimed in claim 1 or claim 2 wherein the upper edge of said first portion is in-turned and is dimensioned to contact the adjacent surface of the window frame.

6. The flashing as claimed in claim 1 wherein said second portion is a flat plate.

7. The flashing as claimed in claim 1 further comprising an end cap adapted to be push fitted over each end of the flashing and dimensioned to close off substantially the whole of the end of the flashing.

8. The flashing as claimed in claim 7 wherein the end cap provides a plate lying in a plane perpendicular to the length of the flashing, the side of the plate which contacts the flashing in use being formed with grooves dimensioned to be press-fitted over the edges of the third and fourth portions.

9. The combination of a window frame and a flashing as claimed in claim 1 or claim 7.
